(19) United States
(12) Patent Application Publication
(10) Pub. No.: US 2019/0027300 A1
(43) Pub. Date: Jan. 24, 2019

(54) Winding Arrangement With Foot For Vertical Potting

(71) Applicant: SIEMENS AKTIENGESELLSCHAFT, MUENCHEN (DE)

(72) Inventors: TIM-FELIX MAI, WENDLINGEN (DE); RICHARD SILLE, KIRCHHEIM (DE); STEFFEN WEINERT, WANGEN (DE)

(21) Appl. No.: 16/069,892

(22) PCT Filed: Dec. 15, 2016
(86) PCT No.: PCT/EP2016/081112

§ 371 Date: Jul. 13, 2018

(30) Foreign Application Priority Data
Jan. 15, 2016 (DE) 10 2016 200 457.3

(51) Int. Cl. H01F 27/32; H01F 41/12

(52) U.S. Cl. CPC H01F 27/323; H01F 41/127; H01F 41/122; H01F 27/327

(57) ABSTRACT

A winding arrangement has a number of winding sections arranged one above the other in the axial direction. The winding sections are arranged at a distance from each other and are electrically interconnected such that they form a series connection. The winding arrangement allows vertical potting with a winding insulation. At least one foot element is provided, which is connected to a winding section and is configured to carry the entire winding arrangement.

The invention relates to a winding arrangement having a number of winding sections that are arranged one above the other in a vertical direction, said winding sections being arranged spaced with respect to one another and are electrically connected to one another so as to form a series connection.

Furthermore, the invention relates to a method for producing a winding arrangement.

Such a winding arrangement and such a method are known from the established practice. By way of example, the catalog published by Siemens AG having the order number E5001-G640-A143-V2 from the year 2014 illustrates on page 5 a winding arrangement that is used as a high-voltage winding for a dry transformer in the field of energy distribution. The winding arrangement illustrated in said catalog comprises disk windings as winding sections that are arranged spaced with respect to one another and are completely embedded in a winding insulator. The winding insulator comprises molded casting feet that are provided with a metal section on their free ends, said metal section being used for placing said winding insulator down on a placing surface.

In the case of the previously known production method, winding sections in the form of disk windings are initially wound onto a winding carrier. The disk windings are held on the winding carrier only by means of a fixed winding cable. The winding arrangement that is formed in this manner is cast in a horizontal position using a resin and the resin is subsequently cured by means of a heating procedure over multiple hours. After curing, the previously known winding arrangement may be positioned in a perpendicular manner and together with further components may form a transformer or a restrictor.

The previously known winding arrangement and the previously known method are encumbered with the disadvantage that the winding arrangement may only be set upright, therefore in other words may be brought into the perpendicular position, after curing the winding insulation. A stable casting foot is only formed at the end of the production process.

The object of the invention is to provide a winding arrangement of the type that is mentioned in the introduction, wherein it is to be possible to set said winding arrangement upright at an early stage.

This object is achieved based on the winding arrangement that is mentioned in the introduction by virtue of at least one foot element that is connected to a winding section and is configured so as to support the entire winding arrangement.

Based on the method that is mentioned in the introduction, the invention achieves this object by virtue of the fact that winding sections are wound onto a winding carrier, the winding layers are embodied from electrical conductors that are insulated with respect to one another, the winding sections are connected to one another via holding means with the result that a winding arrangement is provided that comprises winding sections that are arranged one behind the other in the axial direction, an end-side winding section is connected to a foot element that comprises a foot insulating section, each winding section and each foot element is cast upright using an insulating material and is heated so as to cure the insulating material.

The winding arrangement that is provided in accordance with the invention comprises at least one foot element that is connected to a winding section. The foot element or the foot elements may thus support the entire winding arrangement even if this winding arrangement is set vertically upright. In other words, the winding sections may be placed in a simple manner and consequently by way of example may be cast in an upright position. This simplifies the production of the winding arrangement. The winding section that is connected to each foot is expediently an end-side winding section in other words by way of example the lowest winding section with the result that the one or multiple foot element(s) is/are arranged below the center of gravity of the winding sections that are arranged one above the other. At least three foot elements are advantageously provided within the scope of the invention.

Expediently, the winding arrangement is surrounded at least in part by a winding insulator that is embodied from a solid insulating material. The winding insulator is used as an insulating material of the winding that is at a high voltage potential during its operation. The winding arrangement in accordance with the invention is used by way of example as a high voltage winding of a transformer. Alternatively, the winding arrangement in accordance with the invention is part of a restrictor.

The winding insulating material expediently includes resin. Resin, in particular epoxy resin, is an insulating material that is well-known to the person skilled in the art in this field and said epoxy resin is regularly used in particular to produce so-called cast resin transformers.

In accordance with an expedient further development in relation to this, each foot element comprises an insulating material section that is embodied from an electrically insulating foot insulating material. The insulating material section of the foot element ensures that the necessary electrical insulation is provided between the winding section, which is at a high voltage during operation and is connected to said insulating section, and the ground that is at ground potential and on which the winding arrangement is placed.

In accordance with an expedient further development in relation to this, the winding arrangement is at least in part surrounded by a winding insulator that is embodied from a solid winding insulating material, wherein the coefficient of thermal expansion of the winding insulating material corresponds to that of the foot insulating material. In accordance with this advantageous further development, it is possible to avoid the formation of cracks that by way of example may occur in the case of large temperature increases owing to the different coefficients of thermal expansion. Resin together with the conventional filling materials and additives is considered as a winding insulating material. The winding insulating material and the foot insulating material are advantageously identical.

The insulating material section expediently extends from the aforementioned winding section to a free end region, wherein the end region is configured so as to be able to place the winding arrangement on the ground. The ground is typically at ground potential as was previously stated further above. The free end region is by way of example expediently provided with assembly aids. By way of example, metal inserts having inner threads or outer threads may thus be provided on the aforementioned end region and said threads are fixedly connected to the insulating material section.

Holding means are provided in the case of a preferred embodiment of the invention. The holding means may be fundamentally configured in an arbitrary manner. By way of example, block-shaped holding means are thus provided and the winding sections lie against said holding means. However, it is preferred that holding means are provided that comprise at least one holding element that extends at least into two winding sections that are arranged adjacent to one another, wherein the aforementioned holding element is fixedly connected to the winding sections into which said holding element extends. The holding elements hold the winding sections mutually against one another, wherein a predetermined minimum spacing is maintained. The connection of the winding sections to such holding elements is a cost effective way of connecting the winding sections in a mechanical manner to one another prior to the casting procedure.

In accordance with an expedient further development in relation to this, each holding element is configured as a planar insertion strip. The planar insertion strips may be placed in a particularly simple and easy manner during the winding procedure between the winding layers of the winding sections and may be connected to the winding layers.

Each holding element is expediently a pre-preg. The term “pre-preg” comes from English and is an abbreviation for “pre-impregnated fibers”, an expression that could be translated into German as “vorimprägnierte Fasern”. The term pre-preg is used for a fiber structure that is impregnated with a resin that is not completely cured. The fibers are by way of example glass fibers. The resin of the holding element preferably comprises the same coefficient of thermal expansion as the winding insulation. A particular advantage is achieved if the same resin is used for the two solid material insulators.

Each winding section expediently comprises winding layers that are wound in the radial direction one above the other, wherein the winding layers are insulated with respect to one another and comprise an electrical conductor. The winding sections are by way of example disk windings. The winding sections in accordance with the invention and in particular disk windings are circumferentially closed and delimit a disk winding inner space and by way of example a limb of an iron core and where appropriate a low voltage winding may extend through said disk winding inner space.

In accordance with an expedient further development in relation to this, the winding layers in the respective winding section are fixedly connected to one another. In contrast to the prior art, the winding layers and consequently each winding section are held in a stable arrangement in this manner. In combination with the holding elements and the foot element a free standing vertical winding arrangement is provided prior to being embedded in the winding insulation. In other words, the winding sections that are stacked one above the other may be cast upright without a winding carrier. This renders it possible to embed the winding sections in the winding insulator with the result that an arbitrary increase in the wall thickness of the winding insulation is rendered possible.

The winding layers are expediently fixedly connected to one another by means of a cured resinous connection. The resin that is used for the connection is by way of example the same resin that was also used to form the winding insulation.

Each winding section is expediently circumferentially closed, wherein the winding sections are arranged flush with respect to one another. The flush arrangement is necessary in order to provide an inner hollow space for receiving a limb of a core that comprises a low magnetic resistance in comparison with the ambient air, with the result that magnetic flux that is generated by the winding arrangement spreads almost exclusively in the free limb of the core.

Each foot element and each winding section is advantageously completely embedded in a solid material insulation. The complete embedding arrangement increases the degree of electrical insulation, with the result that the winding arrangement may be influenced with higher voltages without it being necessary to space said winding arrangement further from components that are at ground potential.

The solid material insulation expediently delimits an inner hollow space, wherein a continuous inner wall is provided between the inner hollow space and each winding section, said inner wall comprising a thickness between 1 mm and 50 mm. In accordance with this advantageous further development, the thickness of the insulating layer in the interior of the winding arrangement is considerably increased with respect to the previously known winding arrangements. The thickness of the inner wall of the solid material insulation is delimited in particular by means of the production method if the winding sections are held on a winding carrier by means of a winding cable alone and it is necessary for said winding sections to be cast with said winding cable. However, if the winding arrangement comprises foot elements and holding means for holding the winding elements, the winding carrier may thus be removed and the winding arrangement may be cast freely upright on the foot elements. The inner wall of a casting mold may consequently be spaced at an arbitrary distance from the inner winding layers of each winding section. This spacing corresponds to the subsequent wall thickness of the solid material insulation.

In accordance with an expedient embodiment of the method in accordance with the invention, the winding layers are adhered together prior to the procedure of curing the resin that is not completely cured. The resin is by way of example a component of an insulating material that is impregnated with resin. A surface insulating material that is impregnated with resin that is not completely cured in the B-state is by way of example a “pre-preg”. The resin of a pre-preg is not completely cured. In other words, the polymerization of the resin was interrupted prior to all the binding sites of the resin being completely used. Such an insulating material or pre-preg comprises specific adhesive characteristics, with the result that the winding sections may be wound by way of example on a winding form and may be adhered to one another by means of the pre-preg.

The winding arrangement is advantageously pre-heated after the procedure of adhering the winding layers and after introducing the holding elements, though prior to pouring in the fluid insulating material. This preheating procedure ensures that all the resin is cured in the B-state with the result that in each case fixed connections are provided. An independently-standing winding arrangement is subsequently provided, in which only the winding insulation is missing. This “blank” may be cast upright.

Further expedient embodiments and advantages of the invention are the subject matter of the following description of exemplary embodiments of the invention with reference to the figures of the drawing, wherein identical reference numerals refer to identically-functioning components and wherein

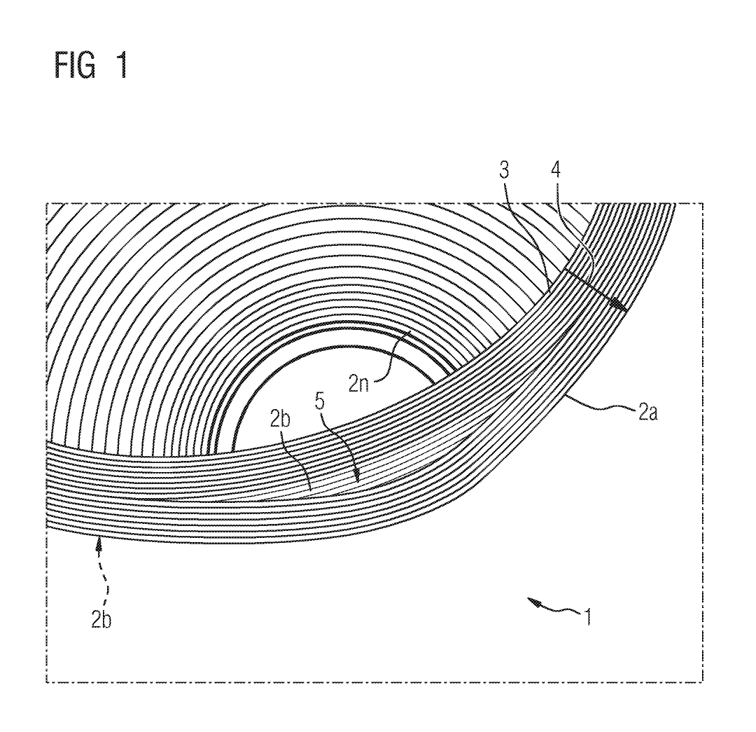

FIG. 1 illustrates a perspective view of a winding arrangement from below,

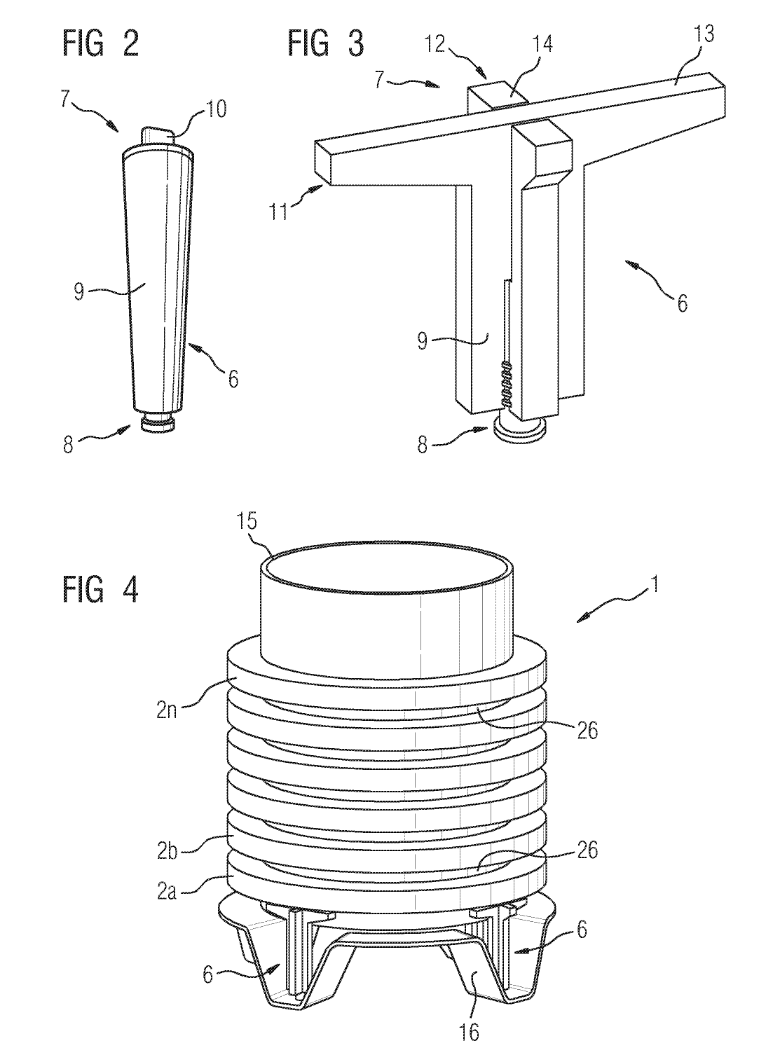

FIG. 2 illustrates a perspective view of a foot element,

FIG. 3 illustrates a further exemplary embodiment of a foot element,

FIG. 4 illustrates a further exemplary embodiment of the winding arrangement in accordance with the invention prior to the casting procedure with fluid winding insulating material,

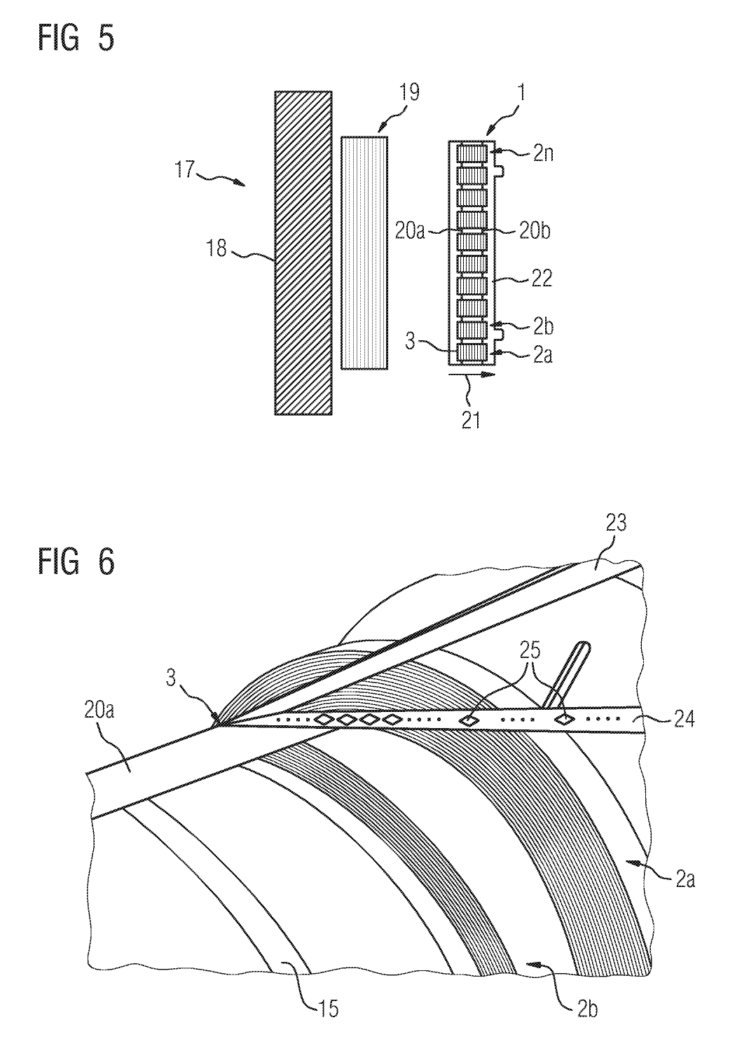

FIG. 5 illustrates an exemplary embodiment of the winding arrangement after the casting procedure and

FIG. 6 illustrates schematically an exemplary embodiment of the method in accordance with the invention.

FIG. 1 illustrates an exemplary embodiment of the winding arrangement 1 in accordance with the invention in a perspective view from below. It is apparent that the winding arrangement 1 comprises a number of disk windings 2, 2b, 2c . . . 2n that are arranged one above the other in a vertical or axial direction, wherein the disk winding 2a is limb the lower disk winding of the winding arrangement 1. It is apparent that the disk winding 2a and also incidentally all the other disk windings 2b . . . 2n are combined from multiple winding layers 3 that comprise a band-shaped, in other words planar, conductor that is wound from the interior towards the outside, wherein the respective disk winding 2a, 2b, 2c . . . 2n increases in size in the radial direction 4. The band-shaped conductors are insulated with respect to one another. The insulation is provided in the exemplary embodiment that is illustrated in FIG. 1 by means of a coating layer that is applied to the conductor. It is apparent in FIG. 1 that the disk winding 2a forms a recess 5 that is configured so as to receive a fastening end of a foot element.

FIG. 2 illustrates an exemplary embodiment of a foot element 6 that comprises a fastening end 7 and also a placing end 8 that is remote from the fastening end 7. An insulating material section 9 that is embodied from an insulating material such as for example an epoxy resin extends between the fastening end 7 and the placing end 8. The foot element 6 forms an inserting support 10 on the fastening end 7, said inserting support being configured so as to be inserted into the recess 5 that is illustrated in FIG. 1. The inserting support is molded in this illustrated example onto the insulating material section 9 and is likewise embodied from a resinous insulating material. A metal assembly means is embedded in the insulating material section 9 on the fastening end 8. The metal assembly means is provided with an inner thread.

FIG. 3 illustrates a further exemplary embodiment of a foot element 6 in accordance with the invention that comprises a foot element 6 and a placing end 8 as illustrated in FIG. 2. As illustrated in FIG. 2 the placing end 8 is provided with metal assembly means that comprise an inner thread in order to be able to securely screw the foot element 6. In contrast to the conical-shaped insulating material section 9 of the exemplary embodiment that is illustrated in FIG. 2, the insulating material section 9 is configured in this case in a cross-shaped manner and comprises two lower sections 11 and 12 that are arranged at a right angle with respect to one another. The lower sections 11 and 12 comprise in each case placing surfaces 13 and 14 that are arranged flush with respect to one another and that are provided so as to receive the lowest disk winding 2a of the winding arrangement 1. It is thus no longer necessary to provide a recess in the lowest disk winding.

FIG. 4 illustrates the foot element 6 that is illustrated in FIG. 3 having the disk windings 2a, 2b . . . 2n that are stacked one above the other and that are all wound together on a winding carrier 15 as holding means and are held on said winding carrier by means of tensile force. The disk windings 2a . . . 2n and also the winding carrier 15 together rest on foot elements 6 that in each case are placed in a concavity of a casting mold 16. After placing said foot elements, the winding carrier may be removed. The blank that is illustrated in FIG. 4 is cast upright using an electrically insulating resin, with the result that the entire winding arrangement 1 including the foot elements 6 is completely embedded in resin. The foot elements 6 extend therefore after the casting procedure into a casting foot that is already considered a part of the prior art, however said casting foot has been crucially improved in this case by virtue of the foot elements for supporting the winding arrangement prior to the casting procedure. In other words, the resinous insulating material provides the necessary rigidity for holding the winding arrangement. The winding arrangement 1 that is illustrated in FIG. 4 is used by way of example as a high voltage winding of a transformer, wherein a low voltage winding and also a limb of a magnet core extend into the interior of said transformer.

Furthermore, in addition to the winding carrier 15, the winding arrangement 1 comprises further holding elements 26 in the form of annular spacers 26. In contrast to the illustrated exemplary embodiment, the holding means may also comprise holding blocks that are configured as block-shaped. These mentioned holding elements may also provide the necessary holding arrangement for the winding sections without the winding carrier 15, with the result that the winding carrier 15 may be removed.

FIG. 5 illustrates schematically a transformer 17 having a limb 18 of an iron core and also a low voltage winding 19 and an exemplary embodiment of a winding arrangement 1 in accordance with the invention and said winding arrangement is used as a high voltage winding. It is apparent that holding elements 20a and 20b extend as holding means between the disk windings 2a, 2b . . . , 2n. The holding elements 20a and 20b are in each case configured as planar insertion strips and extend in each case through all the disk windings 2a, 2b, 2n of the winding arrangement 1. Moreover, the winding layers 3 of each winding section 2a, 2b, 2n are apparent in FIG. 5. In the exemplary embodiment that is illustrated in FIG. 5, the winding layers 3 are wound from an inner side, which is facing the limb 18, in the radial direction 21 towards the outside. As the number of winding layers 3 increases, each winding section 2a, . . . , 2n therefore increases outward in size. The holding means 20a and 20b extend between the winding layers 3 and are fixedly connected to said winding layers, with the result that the winding sections 2a, . . . , 2n are held by the holding elements 20a and 20b at a spacing with respect to one another. For this reason, it is possible to cast the winding insulating material in fluid form with the winding sections 2a, 2b, . . . , 2n and subsequently to completely cure the winding insulating material by means of heating under a vacuum, with the result that a dry winding 1 is provided as a winding arrangement, the winding sections of said winding arrangement being completely embedded in a fixed winding insulator 22. Moreover, it is apparent in FIG. 5 that the winding layers extend in an annular manner in a horizontal layer with the result that the winding sections 2a, 2n provide so-called disk windings. The disk windings 2a, 2n are circumferentially closed, with the result that the limb 18 together with the low voltage winding 19 extends in the interior of each disk winding 2a, 2n.

FIG. 6 illustrates the procedure of winding the winding section 2b. It is apparent that a metal band conductor 23 is wound together with an insulating foil 24 onto an already wound winding layer of the winding section 2b. Initially, the insertion strip 20a is inserted as a holding means. The insertion strip 20a is a pre-preg and is embodied from a fiber glass reinforced resin. The resin of the insertion strip 20a is not completely cured. The holding element 20a that is wound in this manner is preheated after the holding element 20b has been wound into a subsequent winding layer, with the result that a fixed connection is provided between the respective winding sections or disk windings 2a, 2n and the pre-pregs. The winding carrier 15 may subsequently be removed, wherein the holding elements 20a and 20b may hold the disk windings 2a and 2b . . . 2n without a winding insulation 22 at a spacing with respect to one another.

Furthermore, it is apparent that the insulating foil 24 comprises diamond-shaped regions 25 in which said insulating foil is impregnated or coated with a resin in the B-state. The diamond-shaped regions 25 are provided on the two sides of the insulating foil 24, wherein the resin is applied in a punctiform manner in the diamond-shaped regions. During the curing procedure after the winding procedure, the foils 24 adhere the band conductors 23 to one another. The resin in the diamond-shaped regions also cures by means of the preheating procedure, with the result that the aforementioned connection between the winding layers 3 is reinforced. The resin in the diamond-shaped regions may therefore be referred to as layer connecting means.

1-19. (canceled)

20. A winding arrangement, comprising:
a plurality of winding sections arranged one above another in an axial direction;
said winding sections being spaced with respect to one another and electrically connected to one another so as to form a series circuit; and
at least one foot element connected to one of said winding sections and configured to support the winding arrangement in its entirety.

21. The winding arrangement according to claim 20, comprising a winding insulator formed of a solid winding insulating material surrounding said winding sections and said at least one foot element at least in part.

22. The winding arrangement according to claim 21, wherein said winding insulating material includes a resin.

23. The winding arrangement according to claim 20, wherein said foot element comprises an insulating material section formed of an electrically insulating foot insulating material.

24. The winding arrangement according to claim 23, comprising a winding insulator formed of a solid winding insulating material at least in part surrounding each said winding section and said at least one foot element, wherein a coefficient of thermal expansion of said winding insulating material equals a coefficient of thermal expansion of said foot insulating material.

25. The winding arrangement according to claim 23, wherein said insulating material section extends from the one winding section to a free end region, and wherein the end region is configured to receive and support the winding arrangement.

26. The winding arrangement according to claim 20, which comprises a holding device having at least one holding element that extends between at least two mutually adjacent winding sections, wherein the one holding element is fixedly connected to said winding sections into which said holding element extends.

27. The winding arrangement according to claim 26, wherein said at least one holding element is one of a plurality of holding elements each being a planar insertion strip.

28. The winding arrangement according to claim 27, wherein each said holding element is embodied from a resin that is reinforced with fibers.

29. The winding arrangement according to claim 28, wherein each said winding section comprises winding layers that are wound one above another, and wherein said winding layers are insulated with respect to one another and comprise an electrical conductor.

30. The winding arrangement according to claim 29, which comprises layer connecting devices fixedly connecting said winding layers to one another.

31. The winding arrangement according to claim 30, wherein said winding sections are fixedly connected to one another by way of a cured resinous connection.

32. The winding arrangement according to claim 31, wherein each said winding section is circumferentially closed, and wherein said winding sections are arranged flush with respect to one another.

33. The winding arrangement according to claim 32, wherein said foot element and each said winding section are completely embedded in a winding insulator.

34. The winding arrangement according to claim 33, wherein said winding insulator is disposed to delimit an inner hollow space and a continuous inner wall of winding insulating material is disposed between said inner hollow space and each winding section, and wherein said continuous inner wall has a thickness between 1 mm and 50 mm.

35. A method of producing a winding arrangement, the method comprising:
forming winding sections by winding winding layers onto a winding carrier, the winding layers being electrical conductors that are insulated from one another;
connecting the winding sections to one another via holding devices to provide a winding arrangement with winding sections that are arranged one above another in an axial direction;
connecting an end-side winding section to at least one foot element that includes a foot insulating section;
casting each winding section and the at least one foot element in an upright position with an insulating material; and
heating the insulating material so as to cure the insulating material.

36. The method according to claim 35, wherein the step of connecting the winding sections comprises inserting at least one holding element between the winding layers during the step of winding the winding sections, to cause the holding element to extend between at least two winding sections.

37. The method according to claim 36, which comprises causing the winding layers to adhere to one another by way of a resin that is not completely cured prior to curing the insulating material.

38. The method according to claim 37, which comprises preheating the winding arrangement after adhering the winding layers and after introducing the holding elements, but prior to curing the insulating material.
